(19) United States
(12) Patent Application Publication
(10) Pub. No.: US 2026/0199168 A1
(43) Pub. Date: Jul. 16, 2026

(54) USE OF PASSIVE PRESSURE TO IMPROVE BONE DENSITY

(71) Applicant: Kenneth L. Willeford, Little River, SC (US)

(72) Inventor: Kenneth L. Willeford, Little River, SC (US)

(21) Appl. No.: 19/021,862

(22) Filed: Jan. 15, 2025

(51) Int. Cl. A61H 1/00

(52) U.S. Cl. CPC A61H 1/006; A61H 2201/0103; A61H 2201/1633; A61H 2201/5053; A61H 2203/0431

(57) ABSTRACT

Passive pressure may be used to improve bone density, which may be used to treat osteopenia and osteoporosis. Passive pressure may be applied to a patient's hip area, at or near the greater trochanters of the left and right hips of the patient. This may be performed using an apparatus having left and right side members and/or inflatable bladders that may be pressed against the sides of the patient's hip at or near the greater trochanters of the left and right femur bones.

### FIELD OF ENDEAVOR

Aspects of the present invention relates to the treatment of osteoporosis and/or osteopenia of the hip using passive pressure.

### BACKGROUND

Osteoporosis is a significant human health condition. The prevalence of osteoporosis exceeds 14 million people. It is a metabolic bone disease that results in low bone density and altered bone architecture and increases the risk of fractures. More than 300,000 adults age 65 and older are hospitalized for hip fractures each year and nearly one in four will die within a year. Osteoporosis-related fractures can increase pain, disability, nursing home placement, total health care costs, and mortality.

The diagnosis of osteoporosis is based on measuring bone mineral density (BMD) using noninvasive dual-energy x-ray absorptiometry (DEXA scans). The results are reported as a T-score. The T-score is the number of standard deviations different when comparing the patient's bone density with healthy young individuals of the same sex. A T-score equal to or above −1.0 is considered normal bone density. A T-score between −1.0 and-2.5 is considered low bone density, sometimes referred to as osteopenia. A T-score −2.5 or below is considered osteoporosis. Osteopenia has a bone density more than one standard deviation below young healthy individuals and osteoporosis has a bone density more than two-and-one-half standard deviations below young healthy individuals.

Nonpharmacological management of osteoporosis includes adequate calcium and vitamin D intake, weight-bearing exercise, smoking cessation, limitation of alcohol/caffeine consumption, and fall-prevention techniques. There are also 14 pharmacologic treatments approved by the U.S. Food and Drug Administration (FDA).

Further techniques for the treatment of osteoporosis and/or osteopenia are desirable in order to treat the large number of patients suffering from these conditions.

### BRIEF SUMMARY OF ASPECTS OF THE DISCLOSURE

Aspects of the present disclosure may pertain to a method of treating osteoporosis and/or osteopenia of the hip, in particular, by means of the use of passive pressure applied laterally to the bilateral greater trochanters of the femur bones of the patient. Such passive pressure may have the effect of providing improved bone density in the hip region of the patient. For purposes of the present disclosure, the term “passive pressure” means that after the application of a device or apparatus there is constant application of force laterally to the bilateral greater trochanters of the femur without further effort or movement of the individual.

### BRIEF DESCRIPTION OF THE DRAWINGS

Aspects of the present disclosure will be presented in further detail in conjunction with the accompanying drawings, in which:

FIG. 1 is an illustration of the human femur with attention to the femoral neck;

FIG. 2 is an illustration of the human pelvis in the standing position with location of passive pressure applied laterally to the bilateral greater trochanters of the femur according to aspects of the present disclosure; and

FIG. 3 is an illustration of the human pelvis in the sitting position, showing an example of passive pressure applied laterally to the bilateral greater trochanters of the femur according to aspects of the present disclosure; and

FIGS. 4 and 5 show views illustrating an example of a mechanical prototype for an apparatus according to aspects of the present disclosure.

### DETAILED DESCRIPTION OF ASPECTS OF THE DISCLOSURE

It has been determined that active weight-bearing exercises, such as squats and lunges, may improve bone density. Bones typically respond to active and intermittent forces by increasing the bone density. The mechanism is incompletely understood. To stimulate the osteogenic effects for bone mass accretion, bone tissues are generally exposed to a mechanical load exceeding mechanical loads experienced during daily living activities. Osteocytes may play a role in the remodeling process by sensing the mechanical loads and transmitting the information to the osteoblasts and osteoclasts, which may then maintain the skeletal homeostasis.

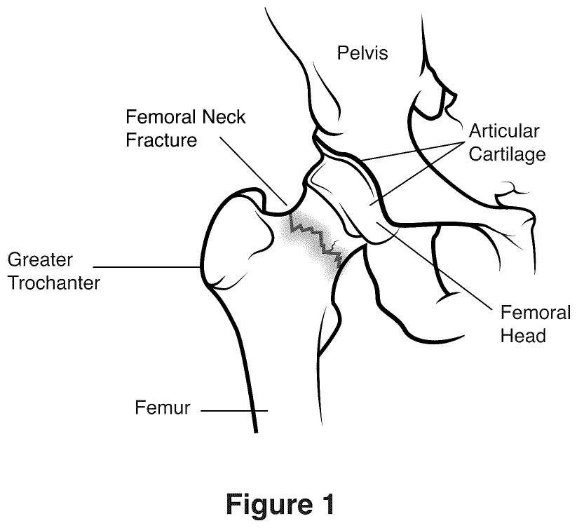

Bone strength prevents fractures, and bone strength is determined by not only bone mineral density but also bone quality factors including bone microarchitecture, geometry, cell turnover, and the material properties of collagen. Bone adaptation to mechanical loading affects not only the bone mineral density but also geometric markers of bone strength. Resistance training increases cortical thickness and bone mineral contents in the femur neck. When there are hip fractures, the location of the fracture is generally in the femoral neck (FIG. 1). This is where the bone density is measured with DEXA scans.

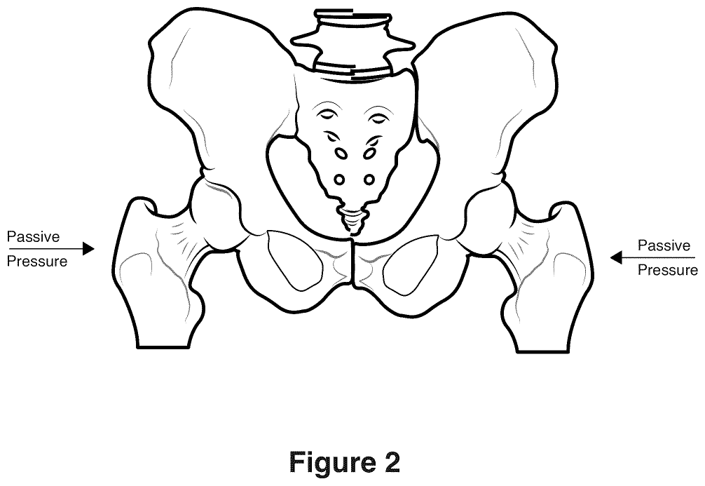

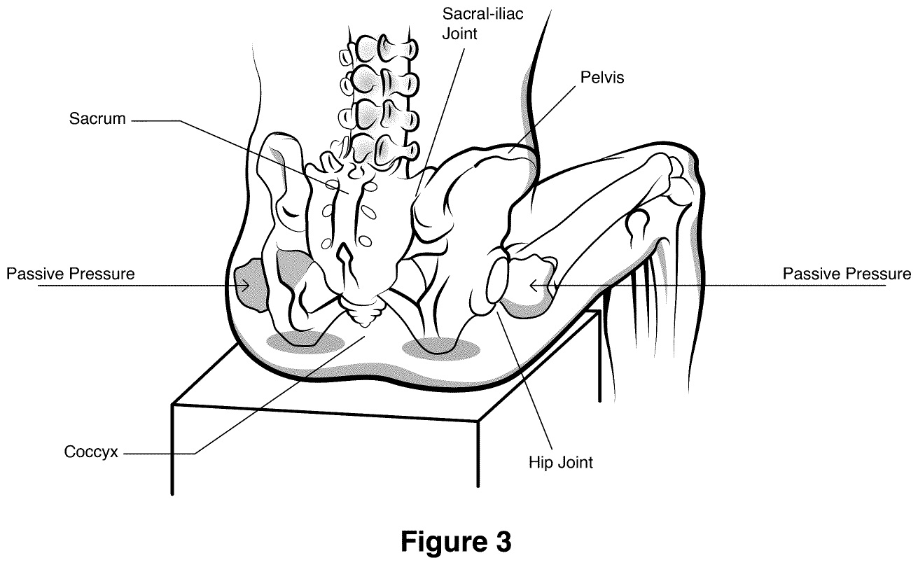

Current treatments relating to exercise for osteoporosis and/or osteopenia of the hip are active and intermittent. A method and an apparatus according to aspects of the present disclosure may, in contrast, be passive and constant with the application of force laterally to the bilateral greater trochanters of the femur, as shown in the example of FIGS. 2 and 3. The greater trochanters may be palpated for proper positioning of the force. The anatomic location of the greater trochanters are adjacent to the femoral neck such that applied forces to the greater trochanters may be transmitted to the femoral neck. The force may be applied in the standing position, as shown in the example of FIG. 2, or in the sitting position, as shown in the example of FIG. 3. The applied force may be pressure, and this may be applied, e.g., mechanically or pneumatically. Both mechanical and pneumatic prototypes have been developed and tested by the inventor. An amount of pressure applied may be as tolerated or may be measured. The pneumatic prototype used a pressure of 200 mm Hg. In testing, both prototypes were used for thirty minutes per day for 6 months. DEXA scans were obtained before and after treatment, and the study determined effectiveness with a statistical level of p≤0.001.

The pneumatic prototype (not shown) used the bladders of sphygmomanometers, which allowed for monitoring the applied pressure. This design allowed for localized placement with one sphygmomanometer bladder over each of the bilateral greater trochanters and fastened to a velvet and Velcro® belt. Circumferential pressure could not be applied in this configuration because the prototype performs like a tourniquet to the lower extremities. However, in an alternative arrangement, the sphygmomanometer bladders could alternatively be mounted on a single belt that may be worn by the patient, circumferentially around the pelvic area, such that the sphygmomanometer bladders are correctly positioned adjacent to the greater trochanters of the patient's femurs. They could also be mounted on a rigid or flexible assembly similar to the mechanical prototypes discussed below, with the difference being that, instead of mechanical pieces applying the pressure by being pressed against the patient's greater trochanters, the mechanical assemblies would position the sphygmomanometer bladders such that the sphygmomanometer bladders may be inflated to apply the pressure. Note that, in general, any suitable inflatable structure (bladder) that may be filled with a fluid (gas (e.g., but not limited to air) or liquid (e.g., but not limited to water)) may be used in place of a sphygmomanometer bladder.

One mechanical prototype, not shown, used a ratchet and a strap mounted to a flexible board in a “C” shape such that the board extended anterior to the pelvis, which was used at the level of the greater trochanters, and the ratchet was used to tighten the strap to pressure as tolerated by the patient. Both prototype devices were used in both the sitting and standing position. A variety of designs could accomplish the same goal of applying passive pressure laterally to the bilateral greater trochanters of the femur.

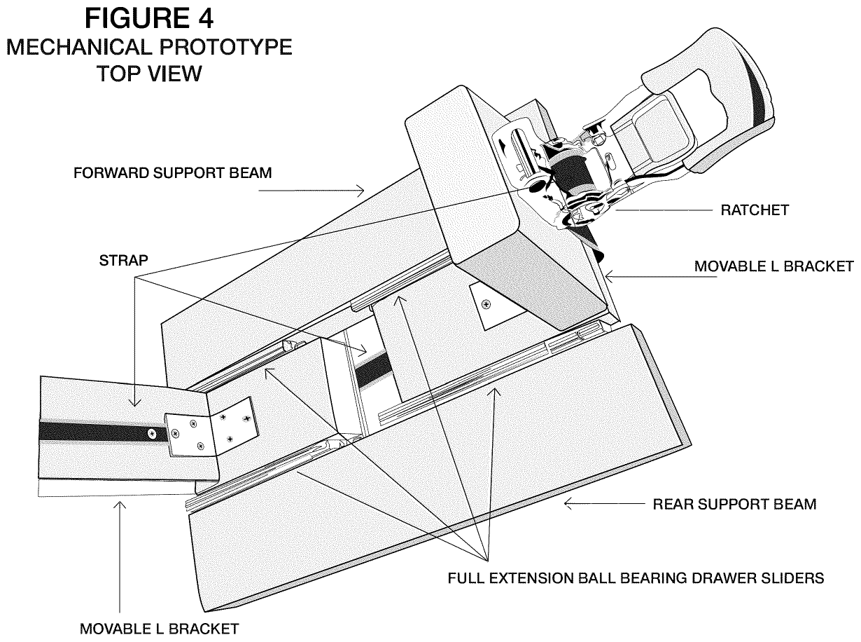

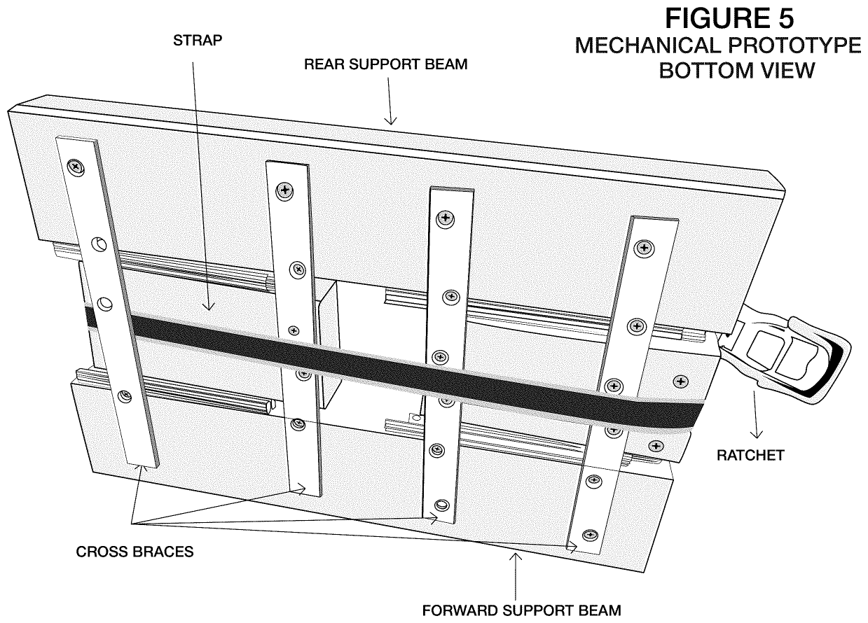

For example, FIGS. 4 and 5 show a second mechanical prototype device according to aspects of the present disclosure. A device was constructed with forward and rear support beams and two movable L-brackets mounted in the middle with upward-extending patient contact pieces (e.g., padded wooden boards or metal or plastic pieces (or combinations of such materials), which may be shaped to fit the contours of a human pelvic area; however, the invention is not thus limited) and lower pieces (e.g., wooden, plastic, and/or metal boards) arranged between the forward and rear support beams. The two L-bracket assemblies (i.e., the combinations of the L-brackets, the patient contact pieces, and the lower pieces) were connected to the forward and rear support beams with full-extension ball bearing drawer sliders. A ratchet was mounted to one L-bracket and was connected by a strap underneath the device to the opposite L-bracket, such that use of the ratchet shortened the strap and decreased the internal distance between the L-brackets. With the height of the L-brackets, this provided passive pressure laterally to the bilateral greater trochanters of the femurs of the patient. This device was used only in the sitting position, where a person sits in the device with the L-bracket assemblies adjacent to the bilateral greater trochanters of the femurs, and the ratchet was used to apply passive pressure laterally to the bilateral greater trochanters of the femur. A range of both pressures and durations of treatment would be expected to be effective. It is anticipated that padding would be used on the surfaces in contact with the patient for patient comfort and that such padding would be designed to fit the contours of a patient while allowing the apparatus to maintain the proper passive pressure.

These prototypes have in common two side members attached to a support member of some type (for example, but not limited to, a strap, a board, a belt, or combinations thereof) or a single assembly (the C-shaped board of the first mechanical prototype) that fit(s) around the patient. The side members (in the above example prototypes, the sphygmomanometer bladders, the ends of the C-shaped board (in this case, the side members may be integral with the support member), the upward-extending pieces attached to L-brackets) may be arranged to apply passive patient to the patient. The passive pressure may be set by an adjustor, which may include, but is not limited to, an adjustment device, such as, but not limited to, a strap, a ratchet, Velcro®, etc.

The techniques according to aspects of the present disclosure differ from prior techniques that utilize intermittent and active force to the skeleton in a vertical axial direction. The present techniques may apply forces laterally to the bilateral greater trochanters to improve bone density of the femoral neck. These techniques may be passive, rather than active, and may be constant over an application period, rather than intermittent, as in the prior art. This may involve sustained forces applied laterally to the bilateral greater trochanters, which is different from isometric contractions or static muscle contraction, which correspond to sustained muscle recruitment and activity with an increase in tension that is accompanied by no change in the length of the recruited muscle tissue or change in joint angle. This method and device is applying force to the bone, there is no muscular contraction. The duration of applied force in this method and device far exceeds isometric contraction exercise duration. The study protocol was 30 minutes per day for 6 months; at least 20 minutes per day is estimated for effectiveness.

Various aspects of the disclosure have been presented above. However, the invention is not intended to be limited to the specific aspects presented above, which have been presented for purposes of illustration. Rather, the invention extends to functional equivalents as would be within the scope of the appended claims. Those skilled in the art, having the benefit of the teachings of this specification, may make numerous modifications without departing from the scope and spirit of the invention in its various aspects.

I claim:

1. A method of improving bone density of a patient, including:
applying passive pressure to left and right sides of a patient in an area of the left and right hips of the patient.

2. The method of claim 1, wherein the passive pressure is applied at the left and right greater trochanters of the patient's left and right femurs.

3. The method of claim 1, wherein the passive pressure is applied in a continuous, non-intermittent fashion for a predetermined length of time per treatment.

4. The method of claim 1, wherein said applying passive pressure comprises:
positioning left and right side members along the respective left and right sides of the patient; and
adjusting the left and right side members to apply the passive pressure.

5. The method of claim 4, wherein said adjusting the left and right side members include inflating respective left side and right side bladders forming or attached to the respective left side and right side members.

6. An apparatus to improve bone density of a patient, including:
a right side member; and
a left side member,
wherein the right side member and the left side member are configured to be applied against right and left sides of the patient's hip area and are further configured to be adjustable to apply passive pressure to the right and left sides of the patient's hip area.

7. The apparatus of claim 6, further including a support member, wherein the right side member and the left side member are coupled to the support member.

8. The apparatus of claim 7, wherein the support member, the right side member, and the left side member are of unitary construction, forming a unitary structure.

9. The apparatus of claim 8, wherein the unitary structure formed by the support member, the right side member, and the left side member is flexible to conform to the patient to apply the passive pressure.

10. The apparatus of claim 7, further comprising an adjustment device adapted to cause the apparatus to apply the passive pressure.

11. The apparatus of claim 10, wherein the adjustment device includes at least one strap configured to enable a non-patient user to draw the right side member and the left side member against the right and left sides of the patient's hip area.

12. The apparatus of claim 7, wherein the support member is configured to enable the right side member and the left side member to be moved toward and away from each other.

13. The apparatus of claim 12, wherein the right side and left side members are attached to the support member in a slidable fashion such that the right side member and the left side member are enabled to be slid toward and away from each other.

14. The apparatus of claim 7, wherein each of the right side member and the left side member includes a respective inflatable bladder to be used to apply the passive pressure.

15. The apparatus of claim 14, wherein each of the right side member and the left side member is applied to the patient independently.

16. The apparatus of claim 14, wherein the right side member and the left side member are applied to the patient using a single belt.
